(19) United States
(12) Patent Application Publication
(10) Pub. No.: US 2005/0169281 A1
(43) Pub. Date: Aug. 4, 2005

(54) Distributed router

(76) Inventors: Eun-Sook Ko, Suwon-si (KR); Byung-Gu Choe, Seoul (KR); Yong-Seok Park, Yongin-Si (KR)

Correspondence Address: Robert E. Bushnell, Suite 300, 1522 K Street, N.W., Washington, DC, 20005-1202, US

(21) Appl. No.: 11/013,802

(22) Filed: Dec. 17, 2004

(30) Foreign Application Priority Data
Feb. 2, 2004 (KR) 2004-6791

(51) Int. Cl. H04L 12/56

(52) U.S. Cl. 370/400

(57) ABSTRACT

A distributed router includes: a number of ports adapted to be connected to peers via a network, to receive messages containing packets and entry information from the peers, and to output the packets for transmission to destinations; a switching fabric adapted to switch the packets received through the respective ports to output the packets to corresponding output ports; and at least one line card adapted to extract the entry information of the peers from the messages received via the input ports, to process the entry information according to a preset routing protocol to determine a best route, and to output the packets received from the peers through the corresponding output ports according to the best route.

### CLAIM OF PRIORITY

This application makes reference to, incorporates the same herein, and claims all benefits accruing under 35 U.S.C. §119 from an application for DISTRIBUTED ROUTER AND ITS ROUTING METHOD earlier filed in the Korean Intellectual Property Office on 2 Feb., 2004 and there duly assigned Serial No. 2004-6791.

### BACKGROUND OF THE INVENTION

1. Field of the Invention

The present invention relates to a distributed router and, more particularly, to a distributed router and its routing method and a program storage device, readable by a machine, tangibly embodying a program of instructions executable by the machine to perform the routing method, in which processing a routing protocol is distributed in the distributed router.

2. Description of the Related Art

Routers generally include four components: an input port, an output port, a switching fabric, and a routing processor.

The input port is a contact point with a physical link and receives packets from the outside. The switching fabric provides an internal connection between the input port and the output port.

The output port stores packets and performs scheduling in order to transmit the packets to an output link.

The routing processor processes a routing protocol, and generates a forwarding table used to forward the packets.

When a routing function is implemented by software which is executed in a processing environment, the processing performance of the software must catch up with an input speed of the packets. If not, a bottleneck phenomenon occurs.

Currently, Internet traffic has been exponentially increasing. Therefore, in order to accept an increase in the Internet traffic, there has been a proposal for a distributed router having a distributed structure.

The following patents each discloses features in common with the present invention but do not teach or suggest the inventive features specifically recited in the present claims: U.S. Patent Application No. 2003/0198221 to Kim et al., entitled METHOD FOR DETECTING PROBLEMS IN ROUTING PROTOCOL MODULES OF DISTRIBUTED ROUTER, published on Oct. 23, 2003; U.S. Patent Application No. 2003/0217242 to Wybenga et al., entitled SYSTEM AND METHOD FOR SYNCHRONIZING A PLURALITY OF PROCESSORS IN A PROCESSOR ARRAY, published on Nov. 20, 2003; and U.S. Patent Application No. 2004/0085897 to Jacobi et al., entitled METHOD AND APPARATUS FOR HIGH PERFORMANCE SINGLE BLOCK SCHEDULING IN DISTRIBUTED SYSTEMS, published on May 6, 2004.

### SUMMARY OF THE INVENTION

Therefore, the present invention provides a distributed router and its routing method, capable of distributing processing of a routing protocol, and avoiding a centralized structure which processes the routing protocol only in a routing processor located at a central unit of the router.

In order to achieve the objective, according to one aspect of the present invention, a distributed router is provided including: a plurality of line cards; a routing information storing unit adapted to store routing information of a peer connected to the distributed router via a network; a routing processing unit adapted to determine a best route by processing entry information transmitted from the peer connected via the network according to a preset routing protocol, and to store the routing information of the peer in the routing information storing unit; a routing information exchanging unit adapted to synchronize the routing information between the line cards by establishing an internal communication path with the line cards and exchanging the routing information with the line cards via the internal communication path; and a forwarding processor adapted to generate forwarding information based on the routing information stored in the routing information storing unit and to process at least one packet transmitted from the network.

The routing protocol includes at least one of a Routing Information Protocol (RIP), an Open Shortest Path First (OSPF) protocol, an Inter-gateway Routing Protocol (IGRP), an Integrated Intermediate System to Intermediate System (IS-IS) protocol, an Exterior Gateway Protocol (EGP), and a Border Gateway Protocol (BGP).

The routing processing unit is adapted to determine the best route by processing the entry information changed according to the routing protocol and to store the changed routing information upon the changed routing information being transmitted from the peer.

The routing processing unit is adapted to delete the routing information of the peer from the routing information storing unit upon no entry information being transmitted from the peer for a predetermined time period.

The routing processing unit includes: a message processing unit adapted to transmit an entry information request message and to receive the entry information transmitted in response to the entry information request message upon the peer being connected; and a route determining unit adapted to determine the best route by processing the entry information received through the message processing unit according the preset routing protocol and to store the routing information in the routing information storing unit.

The message processing unit is adapted to transmit the routing information in a predetermined period or to transmit the routing information upon the routing information being changed.

The route determining unit is adapted to determine the best route based on the changed entry information and to store changed routing information upon changed entry information being transmitted from the peer.

The routing information exchanging unit includes: a path establishing unit adapted to establish the internal communication path with the line cards; a path storing unit adapted to storing information for the internal communication path established by the path establishing unit; and a routing information synchronizing unit adapted to exchange the routing information with the line cards via the internal communication path established by the path establishing unit and to store routing information identical to the routing information stored in the line cards in the routing information storing unit.

The path storing unit is adapted to store at least one of information of a line card connected to the internal communication path established by the path establishing unit, information as to whether or not the internal communication path with a line card has been established, and information on a state of the internal communication path.

The path establishing unit is adapted to disconnect the established internal communication path and to store the disconnection of the internal communication path in the path storing unit upon at least one of the line cards being uninstalled from the distributed router.

The routing information synchronizing unit is adapted to transmit the changed routing information to the line cards through the internal communication path upon the routing information for the peers connected to the line cards being changed, and to update the stored routing information upon the changed routing information being received from the line cards.

The routing information synchronizing unit is adapted to delete the routing information of the peer connected to a line card from the routing information storing unit and to inform the line cards that the routing information has been deleted upon at least one of the line cards being uninstalled from the distributed router.

In order to achieve the objective, according to another aspect of the present invention, a distributed router is provided including: a plurality of ports adapted to be connected to peers via a network, to receive messages containing packets and entry information from the peers, and to output the packets for transmission to destinations; a switching fabric adapted to switch the packets received through the respective ports to output the packets to corresponding output ports; and at least one line card adapted to extract the entry information of the peers from the messages received via the input ports, to process the entry information according to a preset routing protocol to determine a best route, and to output the packets received from the peers through the corresponding output ports according to the best route.

The line card includes: a routing information storing unit adapted to store routing information on a peer; a routing processor adapted to determine the best route according to the entry information received via the respective input ports and to store the routing information of the best route in the routing information storing unit; and a forwarding processor adapted to generate forwarding information based on the routing information stored in the routing information storing unit, to search the output ports of the packets received through the respective output ports from the forwarding information and to output the packets to the corresponding output ports.

In order to achieve the objective, according to still another aspect of the present invention, a routing method is provided including: installing a plurality of line cards in a distributed router; producing and storing routing information on peers connected via a network according to a routing protocol at respective line cards; establishing an internal communication path between the line cards and exchanging the routing information stored in the line cards via the established internal communication path to synchronize the routing information; transmitting the changed routing information via the internal communication path to the line cards and maintaining synchronization of the routing information upon the line cards having the routing information being changed; generating forwarding information based on the stored routing information in the line cards; and performing forwarding by a certain line card according to the generated forwarding information upon at least one packet being received.

The routing method further includes: deleting the routing information of the peers and informing the line cards of the deletion of the routing information upon a connection between the certain line card and the peer being released; and determining a best route according to the entry information of the peer to store new routing information, and transmitting the new routing information to the line cards upon the certain line card being connected to a new peer.

The routing method further includes: establishing an internal communication path with a certain line card and storing information on the internal communication path upon the line card being newly installed in the distributed router; determining the best route according to the entry information of the peer connected to the certain line card to store the routing information, and transmitting the routing information to the line cards through the internal communication path; and disconnecting the internal communication path from the line card and storing information on the disconnection of the internal communication path upon the certain line card being uninstalled from the distributed router.

The routing protocol includes at least one of a Routing Information Protocol (RIP), an Open Shortest Path First (OSPF) protocol, an Inter-gateway Routing Protocol (IGRP), an Integrated Intermediate System to Intermediate System (IS-IS) protocol, an Exterior Gateway Protocol (EGP), and a Border Gateway Protocol (BGP).

In order to achieve the objective, according to yet another aspect of the present invention, a routing method is provided including: installing a plurality of line cards in a distributed router; producing and storing routing information for peers connected through a network according to a routing protocol of respective line cards; establishing an internal communication path between the respective line cards, exchanging the routing information stored in the respective line cards through the established internal communication path, and synchronizing the routing information; processing entry information of the peer according to the preset routing protocol to determine a best route, and transmitting the routing information to the line cards through the internal communication path upon the peer being connected to a certain line card through the network; deleting the routing information of the peer and transmitting information on the deletion of the routing information to other line cards upon the certain line card being disconnected from the peer; determining the best route based on the entry information of the peer according to the preset routing protocol to store new routing information and transmitting the new routing information to other line cards upon a new peer being connected to the certain line card; and generating forwarding information based on the routing information stored in respective line cards and performing forwarding according to the generated forwarding information upon at least one packet being received.

The routing protocol includes at least one of a Routing Information Protocol (RIP), an Open Shortest Path First (OSPF) protocol, an Inter-gateway Routing Protocol (IGRP), an Integrated Intermediate System to Intermediate System (IS-IS) protocol, an Exterior Gateway Protocol (EGP), and a Border Gateway Protocol (BGP).

In order to achieve the objective, according to yet another aspect of the present invention, a program storage device, readable by a machine, tangibly embodying a program of instructions executable by the machine to perform a routing method in a distributed router having a plurality of line cards installed therein is provided, the method including: producing and storing routing information on peers connected via a network according to a routing protocol at respective line cards; establishing an internal communication path between the line cards and exchanging the routing information stored in the line cards via the established internal communication path to synchronize the routing information; transmitting the changed routing information via the internal communication path to the line cards and maintaining synchronization of the routing information upon the line cards having the routing information being changed; generating forwarding information based on the stored routing information in the line cards; and performing forwarding by a certain line card according to the generated forwarding information upon at least one packet being received.

The method further includes: deleting the routing information of the peers and informing the line cards of the deletion of the routing information upon a connection between the certain line card and the peer being released; and determining a best route according to the entry information of the peer to store new routing information, and transmitting the new routing information to the line cards upon the certain line card being connected to a new peer.

The method further includes: establishing an internal communication path with a certain line card and storing information on the internal communication path upon the line card being newly installed in the distributed router; determining the best route according to the entry information of the peer connected to the certain line card to store the routing information, and transmitting the routing information to the line cards through the internal communication path; and disconnecting the internal communication path from the line card and storing information on the disconnection of the internal communication path upon the certain line card being uninstalled from the distributed router.

The routing protocol includes at least one of a Routing Information Protocol (RIP), an Open Shortest Path First (OSPF) protocol, an Inter-gateway Routing Protocol (IGRP), an Integrated Intermediate System to Intermediate System (IS-IS) protocol, an Exterior Gateway Protocol (EGP), and a Border Gateway Protocol (BGP).

In order to achieve the objective, according to still another aspect of the present invention, a routing method is provided including: producing and storing routing information for peers connected through a network according to a routing protocol of respective line cards; establishing an internal communication path between the respective line cards, exchanging the routing information stored in the respective line cards through the established internal communication path, and synchronizing the routing information; processing entry information of the peer according to the preset routing protocol to determine a best route, and transmitting the routing information to the line cards through the internal communication path upon the peer being connected to a certain line card through the network; deleting the routing information of the peer and transmitting information on the deletion of the routing information to other line cards upon the certain line card being disconnected from the peer; determining the best route based on the entry information of the peer according to the preset routing protocol to store new routing information and transmitting the new routing information to other line cards upon a new peer being connected to the certain line card; and generating forwarding information based on the routing information stored in respective line cards and performing forwarding according to the generated forwarding information upon at least one packet being received.

The routing protocol includes at least one of a Routing Information Protocol (RIP), an Open Shortest Path First (OSPF) protocol, an Inter-gateway Routing Protocol (IGRP), an Integrated Intermediate System to Intermediate System (IS-IS) protocol, an Exterior Gateway Protocol (EGP), and a Border Gateway Protocol (BGP). In order to achieve the objective, according to yet another aspect of the present invention, a program storage device, readable by a machine, tangibly embodying a program of instructions executable by the machine to perform a routing method in a distributed router having a plurality of line cards installed therein is provided, the method comprising: producing and storing routing information on peers connected via a network according to a routing protocol at respective line cards; establishing an internal communication path between the line cards and exchanging the routing information stored in the line cards via the established internal communication path to synchronize the routing information; transmitting the changed routing information via the internal communication path to the line cards and maintaining synchronization of the routing information upon the line cards having the routing information being changed; generating forwarding information based on the stored routing information in the line cards; and performing forwarding by a certain line card according to the generated forwarding information upon at least one packet being received.

The method further comprises: deleting the routing information of the peers and informing the line cards of the deletion of the routing information upon a connection between the certain line card and the peer being released; and determining a best route according to the entry information of the peer to store new routing information, and transmitting the new routing information to the line cards upon the certain line card being connected to a new peer.

The method further comprises: establishing an internal communication path with a certain line card and storing information on the internal communication path upon the line card being newly installed in the distributed router; determining the best route according to the entry information of the peer connected to the certain line card to store the routing information, and transmitting the routing information to the line cards through the internal communication path; and disconnecting the internal communication path from the line card and storing information on the disconnection of the internal communication path upon the certain line card being uninstalled from the distributed router.

The routing protocol includes at least one of a Routing Information Protocol (RIP), an Open Shortest Path First (OSPF) protocol, an Inter-gateway Routing Protocol (IGRP), an Integrated Intermediate System to Intermediate System (IS-IS) protocol, an Exterior Gateway Protocol (EGP), and a Border Gateway Protocol (BGP).

In order to achieve the objective, according to still another aspect of the present invention, a program storage device, readable by a machine, tangibly embodying a program of instructions executable by the machine to perform a routing method in a distributed router having a plurality of line cards installed thereinis provided, the method comprising: producing and storing routing information for peers connected through a network according to a routing protocol of respective line cards; establishing an internal communication path between the respective line cards, exchanging the routing information stored in the respective line cards through the established internal communication path, and synchronizing the routing information; processing entry information of the peer according to the preset routing protocol to determine a best route, and transmitting the routing information to the line cards through the internal communication path upon the peer being connected to a certain line card through the network; deleting the routing information of the peer and transmitting information on the deletion of the routing information to other line cards upon the certain line card being disconnected from the peer; determining the best route based on the entry information of the peer according to the preset routing protocol to store new routing information and transmitting the new routing information to other line cards upon a new peer being connected to the certain line card; and generating forwarding information based on the routing information stored in respective line cards and performing forwarding according to the generated forwarding information upon at least one packet being received.

The routing protocol includes at least one of a Routing Information Protocol (RIP), an Open Shortest Path First (OSPF) protocol, an Inter-gateway Routing Protocol (IGRP), an Integrated Intermediate System to Intermediate System (IS-IS) protocol, an Exterior Gateway Protocol (EGP), and a Border Gateway Protocol (BGP).

### BRIEF DESCRIPTION OF THE DRAWINGS

A more complete appreciation of the present invention, and many of the attendant advantages thereof, will become readily apparent as the same becomes better understand by reference to the following detailed description when considered in conjunction with the accompanying drawings in which like reference symbol indicate or similar components, wherein:

FIG. 1 is a block diagram of a distributed router;

FIG. 2 is a block diagram of a distributed router according to an embodiment of the present invention;

FIG. 3 is a block diagram of a line card of a distributed router according to an embodiment of the present invention;

FIG. 4 is a block diagram of a routing processing unit of a routing processor according to an embodiment of the present invention;

FIG. 5 is a view of a procedure of exchanging messages between a distributed router and external peers according to an embodiment of the present invention;

FIG. 6 is a view of connections between routing processors of respective line cards according to an embodiment of the present invention;

FIG. 7 is a block diagram of a routing information exchanging unit of a distributed router according to an embodiment of the present invention;

FIG. 8 is a view illustrating a procedure of exchanging messages between respective line cards of a distributed router according to an embodiment of the present invention; and

FIGS. 9A and 9B are flowcharts of a routing method of a distributed router according to an embodiment of the present invention.

### DETAILED DESCRIPTION OF THE INVENTION

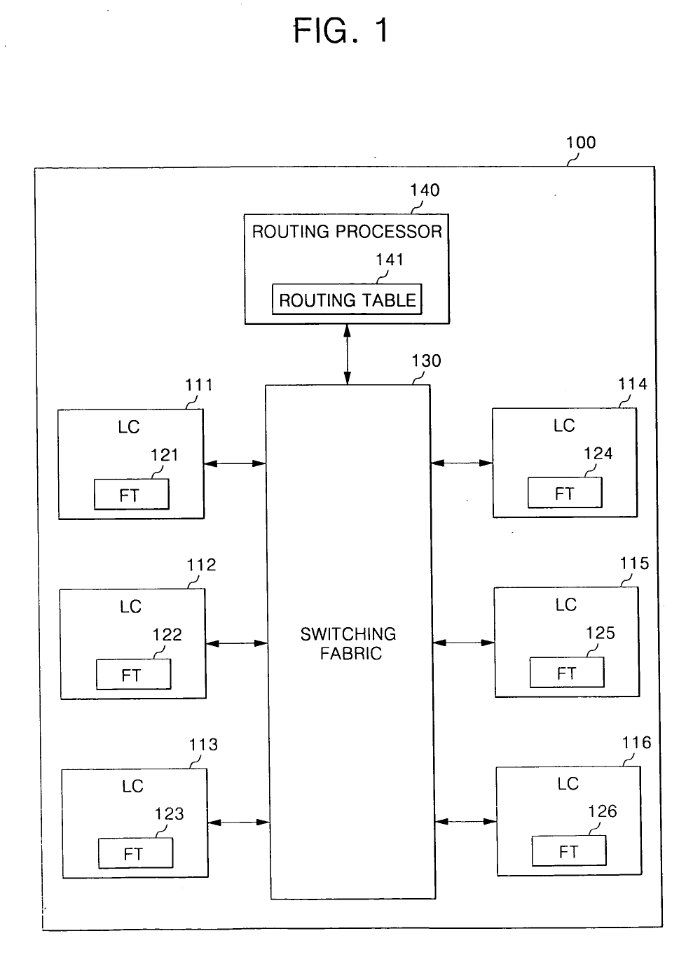

FIG. 1 is a block diagram of a distributed router.

Referring to FIG. 1, the distributed router 100 includes a plurality of Line Cards (LCs) 111 to 116, a switching fabric 130, and a routing processor 140 having a routing table 141.

The LCs 111 to 116 include Forwarding Tables (FTs) 121 to 126, respectively.

The routing processor 140 processes routing to external peers which are respectively connected via the LCs 111 to 116.

That is, when an external peer is connected via a network, the routing processor 140 processes entry information transmitted from the respective external peers according to a routing protocol, thus generating/managing the routing table 141.

The routing protocol processed in the routing processor 140 can be a Routing Information Protocol (RIP), an Open Shortest Path First (OSPF) protocol, a Border Gateway Protocol (BGP), or the like.

The LCs 111 to 116 transmit the entry information from the external peers connected via the network to the routing processor 140 through the switching fabric 130, and download the FTs 121 to 126 from the routing table 141 of the routing processor 140 according to the routing protocol.

The FTs 121 to 126 provide forwarding information, so that the respective LCs 111 to 116 can efficiently access the FTs.

When the packets are transmitted from the external peer connected to the network, the LCs 111 to 116 access their respective FTs 121 to 126 in order to transmit the targeted packet to a final destination, and output the packets to the network via the output port determined from the FTs 121 to 126.

In the distributed router 100, the routing protocol is processed only in the routing processor 140 located at the center thereof.

That is, the FTs 121 to 126 are generated in the routing table 141 which is generated in the routing processor 140 according to the routing protocol, and the LCs 111 to 116 perform forwarding/switching functions of received packets in accordance with the forward information stored in the FTs 121 to 126.

However, the distributed router 100 is simply configured to distribute the forwarding function of the packets to be transmitted, but not to distribute a processing function of the routing protocol.

That is, the structure of processing the routing protocol in the distributed router 100 is a centralized structure where the routing protocol is processed only in the routing processor 140, and also is a server-client structure where the routing processor 140 functions as a server, while each of the LCs 111 to 116 functions as a client.

The FTs 121 to 126 are generated in the routing table 141 which is generated in the routing processor 140 or the server according to the routing protocol, and the FTs 121 to 126 are distributed to the LCs 111 to 116 or to the clients.

The respective LCs 111 to 116 or the clients access the FTs 121 to 126, which are downloaded from the routing processor 140 or the server, to forward the received packets.

All operations of the routing protocol are processed in the routing processor 140 of the distributed router 100. Hence, when the number of external peers to be processed according to the respective routing protocol is increased, the functions of processing the routing protocol in the routing processor 140 suffer from increased loads.

For example, if the routing protocol is an RIP or an OSPF, when the number of external peers connected through the respective LCs 111 to 116 is increased, the messages which are transmitted/received periodically between the routing processor 140 and the external peers according the RIP or OSPF are increased. This results in increasing loads of the routing processor for processing the messages.

Also, when the routing protocol processed in the routing processor 140 is a BGP, both the number of external peers connected through the respective LCs 111 to 116 and the number of transmission control protocol (TCP) connections connected to the distributed router 100 are increased, so that the load of the routing processor 140 is increased.

Further, a load resulting from decision processing where the routing processor 140 decides a best route according to the routing protocol is increased as much as the increase of external peers connected through a network.

Therefore, the distributed router 100 having a centralized structure has a disadvantage in that the network system is limited as to its scalability because the routing protocol is processed only in the central routing processor 140.

An exemplary embodiment of the present invention is described below with reference to the accompanying drawings. In the following description, well-know functions or configurations have not been described in detail to avoid obscuring the invention in unnecessary details.

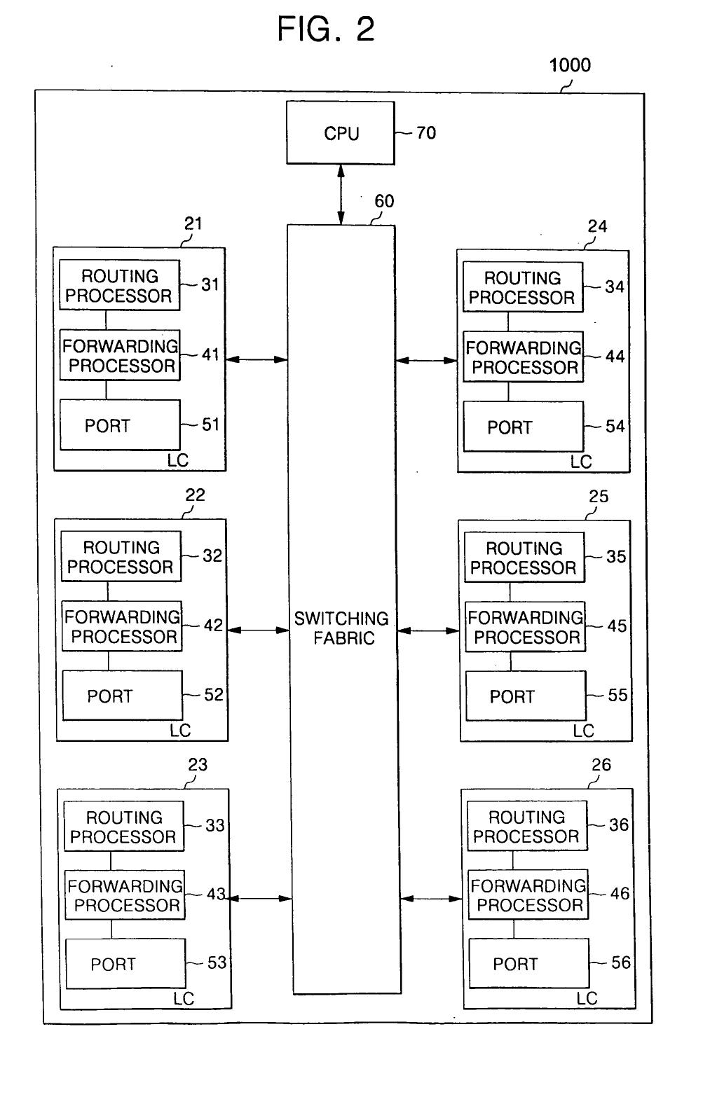

FIG. 2 is s block diagram of a distributed router according to an embodiment of the present invention.

Referring to FIG. 2, the distributed router 1000 includes a plurality of LCs 21 to 26, a switching fabric 60, and a Central Processing Unit (CPU) 70.

The LCs 21 to 26 include routing processors 31 to 36, forwarding processors 41 to 46, and ports 51 to 56, respectively.

The CPU 70 provides the respective LCs 21 to 26 with program information according to a routing protocol inputted through an input unit (not shown), so that the respective LCs 21 to 26 can process the routing protocol.

The respective ports 51 to 56 perform an interfacing operation so that their respective LCs 21 to 26 can be connected to external peers (not shown) via a network, receive packets transmitted from the external peers via the network, and output the packets via the network according to a forwarding operation processed in the respective LCs 21 to 26.

The respective routing processors 31 to 36 of the respective LCs 21 to 26 process the routing protocol according to entry information to generate/manage a routing table, wherein the entry information is transmitted from the respective peers connected through the respective ports 51 to 56.

The respective routing processors 31 to 36 transmit routing information of the generated routing table to the LCs 21 to 26, thus synchronizing routing information of the distributed router 1000.

The routing protocol processed in the routing processors 31 to 36 can be classified as either an Interior Gateway Protocol (IGP) or as an Exterior Gateway Protocol (EGP).

The IGP includes a Routing Information Protocol (RIP), an Open Shortest Path First (OSPF) protocol, an Inter-gateway Routing Protocol (IGRP), an Integrated Intermediate System to Intermediate System (IS-IS) protocol and so on.

The EGP includes a Border Gateway Protocol (BGP) and so on.

The forwarding processors 41 to 46 generate/manage a forwarding table according to the routing information of the routing table generated/managed according to the routing protocol in the routing processors 31 to 36, and forward the packets transmitted from the external peers connected via the ports 51 to 56.

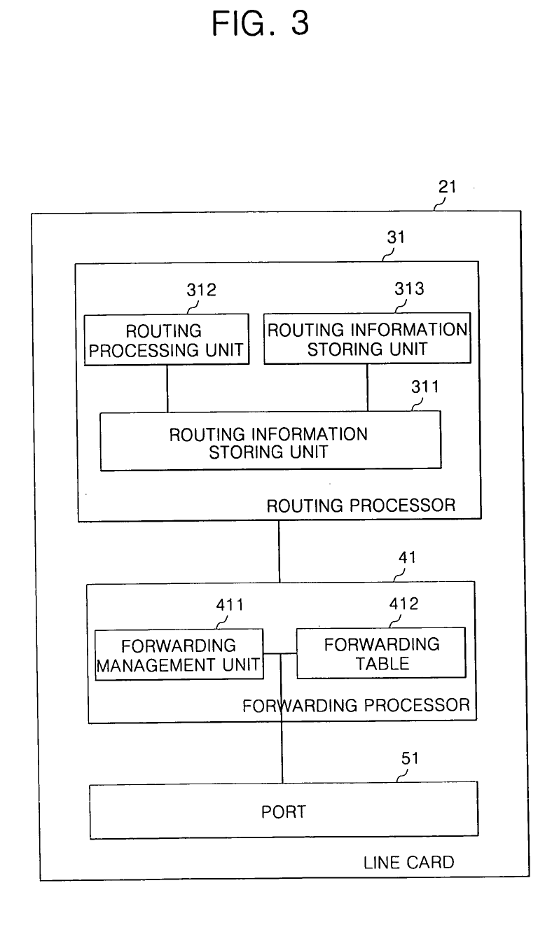

The distributed router 1000 is explained in more detail below with reference to FIG. 3.

FIG. 3 is a block diagram of a line card of a distributed router according to an embodiment of the present invention.

Referring to FIG. 3, LC 21 includes the routing processor 31, the forwarding processor 41, and the port 51. The routing processor 31 includes a routing processing unit 312, a routing information exchanging unit 313, and a routing information storing unit 311. The forwarding processor 41 includes a forwarding management unit 411 and a forwarding table 412.

The routing processing unit 312 of the routing processor 31 transmits an entry information request message to the external peer connected via the port 51, and determines a best route according to a response message containing entry information transmitted from the external peer.

The routing processing unit 312 updates routing information on the determined best route in the routing information storing unit 311, and transmits the updated routing information to the other external peers.

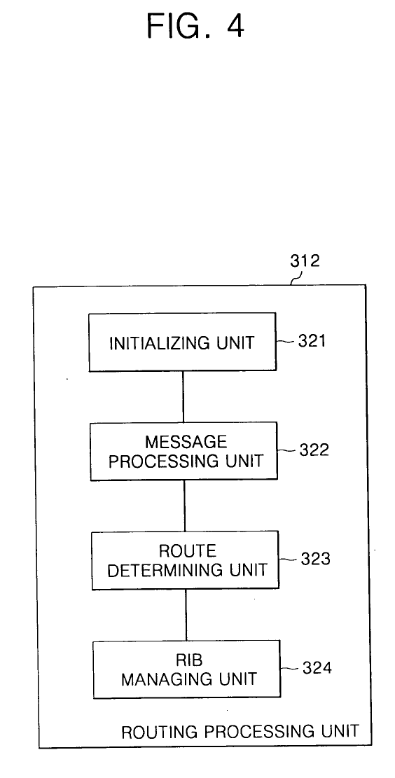

FIG. 4 is a block diagram of a routing processing unit of a routing processor according to an embodiment of the present invention.

Referring to FIG. 4, the routing processing unit 312 includes an initializing unit 321, a message processing unit 322, a route determining unit 323, and a Routing Information Base (RIB) managing unit 324.

When the line card 31 is initially driven or connected to the distributed router 1000, the initializing unit 321 initializes the routing protocol preset in the LC 31 and the routing information of the routing information storing unit 311.

The message processing unit 322 transmits an entry information request signal according to the preset routing protocol, and receives a response message containing the entry information from the external peer when the external peer is connected.

The message processing unit 322 also transmits the updated routing information stored in the routing information storing unit 311 to the other external peers according to the response messages transmitted from the external peers.

The routing determining unit 323 processes the routing information transmitted from the external peer connected via the port 51 according to the routing protocol to determine a best route for the corresponding external peer.

The RIB managing unit 324 stores the routing information on the best route determined by the routing determining unit 323 in the routing information storing unit.

That is, the RIB management unit 324 updates the routing information storing unit 311 when there is routing information to be changed according to the entry information transmitted from the external peer.

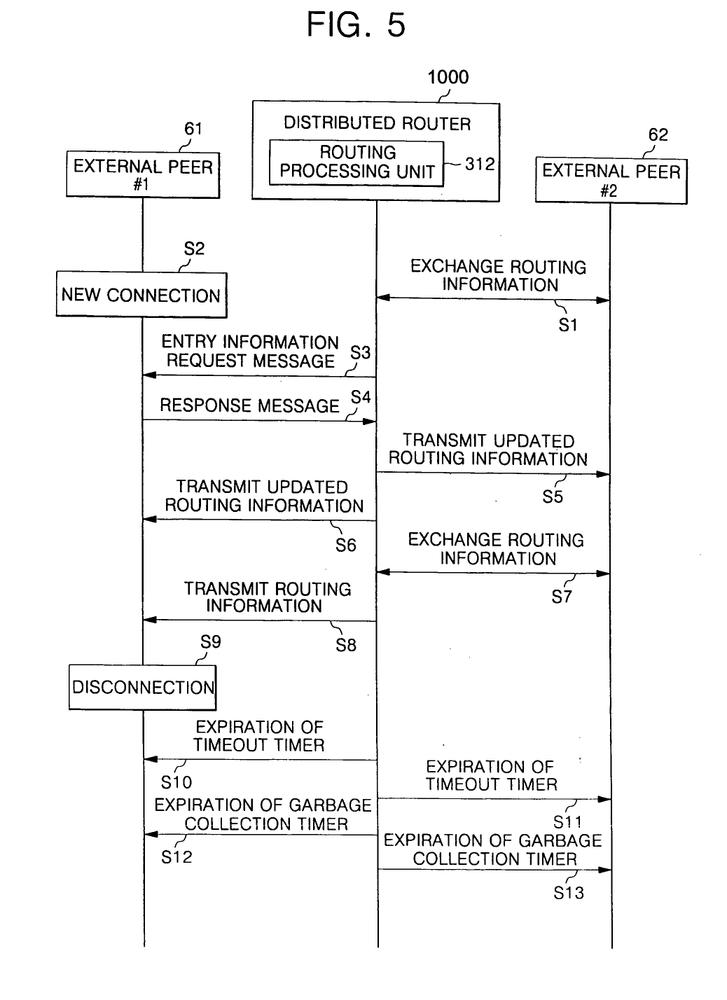

FIG. 5 is a view of a procedure of exchanging messages between the distributed router and the external peer according to an embodiment of the present invention.

A description follows with reference to FIG. 5 regarding the case in which the distributed router 1000 is newly connected to an external peer #1 61 in the state that it has been already connected to an external peer #2 62 through its port 51.

First, the distributed router 1000 is connected to the external peer #2 62 via the network to manage routing information on the external peer #2 62(S1), and the external peer #1 61 is newly connected to the distributed router 1000 via the network (S2).

The routing processing unit 312 initializes the routing protocol and the routing information stored in the routing information storing unit 311 when the corresponding line card 21 is newly installed in the distributed router 1000 or the distributed router 1000 is initially driven.

The message processing unit 322 of the routing processing unit 312 transmits an entry information request message to the external peer #1 61 newly connected via the network (S₃).

The external peer #1 61 transmits a response message containing the entry information to the message processing unit 322 of the routing processing unit 312 in response to the entry information request message (S4).

The message processor 322 of the routing processing unit 312 transmits the response message transmitted from the external peer #1 61 to the route determining unit 323.

The route determining unit 323 processes the entry information contained in the response message transmitted from the external peer #1 61 according to the routing protocol, thereby determining a best route for the external peer #1 61.

The RIB managing unit stores routing information on the best route determined by the route determining unit 323 in the routing information storing unit 311.

The RIB managing unit 324 generates routing information on the external peers 61 and 62 in the routing information storing unit 311 when the distributed router 1000 is initially driven or updates the routing information stored in the routing information storing unit 311 when the routing information has already been generated in the routing information storing unit 311.

Then, the message processing unit 322 transmits the routing information generated or updated in the routing information storing unit 311 to the external peer #2 which has already been connected (i.e., triggers an update) (S5).

The message processing unit 322 can transmit the routing information to the external peers 61 and 62 by periods according to a type of the routing protocol processed in the routing processor 31 or can transmit the routing information to the external peers 61 and 62 only when the routing information has been updated.

When the entry information has been changed, the external peer #1 61 transmits the changed entry information to the routing processing unit 312 of the distributed router 1000 (S6).

The external peer #1 61 can transmit the entry information by periods according to the routing protocol processed in the distributed router 1000 or can transmit the entry information to the distributed router 1000 only when the entry information has been changed.

The message processing unit 322 of the routing processing unit 312 receives the changed entry information from the external peer #1 61, and provides the changed entry information to the route determining unit 323. The route determining unit 323 determines the best route according to the entry information transmitted from the external peer #1 61.

The RIB managing unit 324 stores the routing information of the best route determined by the route determining unit 323 in the routing information storing unit 311.

The message processing unit 322 transmits the changed routing information changed in the routing information storing unit 311 to the external peer #2 62.

The external peer #2 62 transmits the changed entry information to the distributed router 1000 (S6).

That is, the distributed router 1000 transmits the changed routing information of the external peer #1 61 to the external peer #2 62 and transmits the changed routing information of the external peer #2 62 to the external peer #1 61 (S8).

On the other hand, when the distributed router 1000 is disconnected from the external peers #1 61 and #2 62 (S9), the distributed router 1000 checks for the timeout of a timeout timer to determine whether or not a disconnection from the external peers #1 61 and #2 62 has been completed (S10 and S11).

When the timeout timers of the external peers #1 61 and #2 62 have timed out, the distributed router 1000 is disconnected from the external peers #1 61 and #2 62, and the distributed router 1000 then checks for the timeout of a garbage collection timer in order to remove the routing information of the external peers #1 61 and #2 62 from the routing information storing unit 311 (S12 and S13).

After the distributed router 1000 checks for the timeout of the garbage collection timers of the external peers #1 61 and #2 62, if no response is received from the external peers #1 61 and #2 62 within the timeout of the garbage collection timer, the RIB managing unit 324 deletes the routing information on the external peers #1 61 and #2 62 from the routing information storing unit 311.

The routing information exchanging unit 313 of the routing processor 31 connects a communication path between the respective LCs 21 to 26 installed in the distributed router 1000 and exchanges the routing information stored in the routing information storing units of the other LCs 21 to 26, thereby synchronizing the routing information.

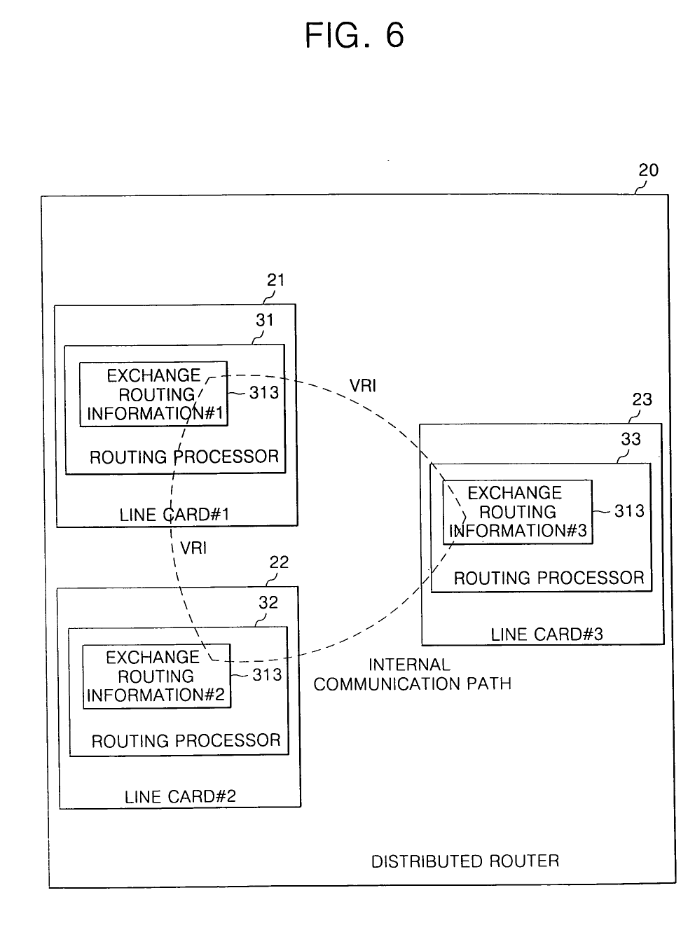

FIG. 6 is a view of internal connections between the routing processors of respective LCs 21 to 26 according to an embodiment of the present invention.

As shown in FIG. 6, the routing processors 31 to 36 of the LCs 21 to 26 must establish 21 an internal communication path in order to maintain the routing information of the same routing information storing units 311.

That is, the internal communication path (hereinafter, referred to as “VRI (virtual router interface)”) must be established among the routing processors 31 to 36 of the respective LCs 21 to 26, and such a communication path can be established by a reliable communication path establishing method, such as a TCP channel establishing method, a multicast channel establishing method, or a unicast channel establishing method.

When the routing information on the external peer connected through the port 51 is changed, the routing information exchanging unit 313 transmits the changed routing information to the other external LCs 21 to 26 and stores the changed routing information in the routing information storing unit 311.

The routing information exchanging unit 313 also manages the VRI connected to the other LCs 21 to 26.

That is, the routing information exchanging unit 313 establishes the VRI with the routing processors 31 to 36 of the newly installed LCs 21 to 26, and reserves information on the VRI established with the LCs 21 to 26 when the LCs 21 to 26 are uninstalled, so that the VRI information can be referred to when the VRI is established with the newly installed LCs 21 to 26.

The routing information exchanging unit 313 preferably minimizes the messages exchanged through the VRI established with the other LCs 21 to 26, so that a load applied to the VRI, that is—the internal communication path of the distributed router 1000, can be minimized.

A path storing unit 334 stores information on the VRI that the routing information exchanging unit 313 has established with the other LCs 21 to 26.

That is, the path storing unit 334 stores the VRI information established between the installed LCs 21 to 26 and information as to whether to drive the corresponding LCs 21 to 26.

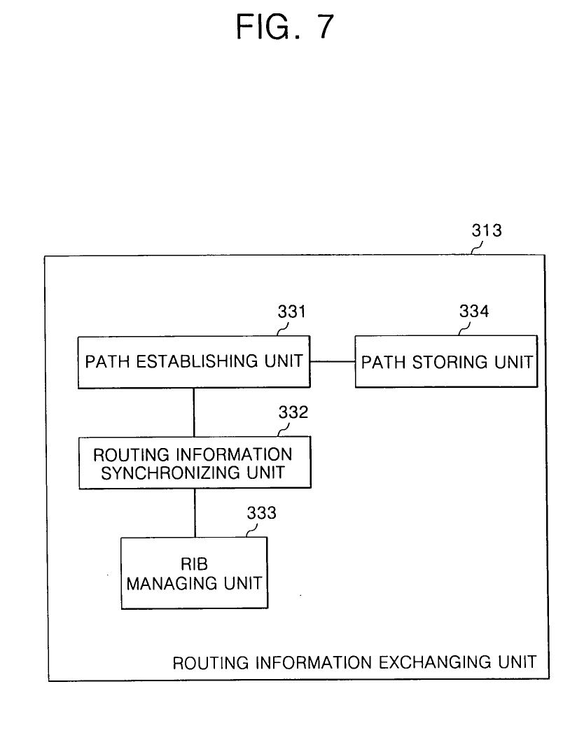

FIG. 7 is a block diagram of a routing information exchanging unit of a distributed router according to an embodiment of the present invention.

Referring to FIG. 7, the routing information exchanging unit 313 of the distributed router 1000 includes a path establishing unit 331, a routing information synchronizing unit 331, a RIB managing unit 333, and a path storing unit 334.

The path establishing unit 331 initializes a VRI connected between the routing processors 31 to 36 of the respective LCs 21 to 26 when the distributed router 1000 is initially driven.

In other words, the path establishing unit 331 initializes the VRI to be established to synchronize the routing information of the routing information storing unit 311 stored in the respective LCs 21 to 26 when the distributed router 1000 is initially driven or the new LCs 21 to 26 are installed.

The path establishing unit 331 establishes the VRI with the routing processors 31 to 36 of the other LCs 21 to 26 and stores information on the established VRI in the path storing unit 334.

When the other LCs 21 to 26 are uninstalled and the VRI is disconnected or when new LCs 21 to 26 are installed and the VRI is established, the path establishing unit 331 stores the resulting VRI information in the path storing unit 334.

The routing information synchronizing unit 332 synchronizes the routing information via the VRI established with the routing processors 31 to 36 of the other LCs 21 to 26 when the distributed router 1000 is initially driven or the new LCs 21 to 26 are installed.

That is, when the new VRI is established with the routing processors 31 to 36 of the other LCs 21 to 26, the routing information synchronizing unit 332 transmits a routing information request message via the VRI and receives a response message containing the routing information transmitted from the other LCs 21 to 26.

In order to minimize a load of the VRI or the internal communication path of the distributed router 1000, the routing information synchronizing unit 332 can transmit only the routing information according to the entry information transmitted from the external peers connected via the ports 51 to 56.

Preferably, when the changed entry information is transmitted from the external peers when the routing information has been synchronized with the other LCs 21 to 26, the routing information synchronizing unit 332 immediately transmits the routing information transmitted from the external peers via the VRI to the other LCs 21 to 26, and then maintains synchronization of the routing information.

In addition, the routing information synchronizing unit 332 can periodically transmit the routing information to the other LCs 21 to 26 according to the routing protocol processed in the routing processors 31 to 36 or transmit the routing information to the other LCs 21 to 26 only when changed routing information exists.

The RIB managing unit 333 manages the routing table according to the routing information transmitted from the other LCs 21 to 26.

The RIB managing unit 333 generates the routing information storing unit 311 according to the routing information when the routing information is received through the routing information synchronizing unit 332 or updates the routing information storing unit 311 using the received routing information when the routing information storing unit 311 has been already generated.

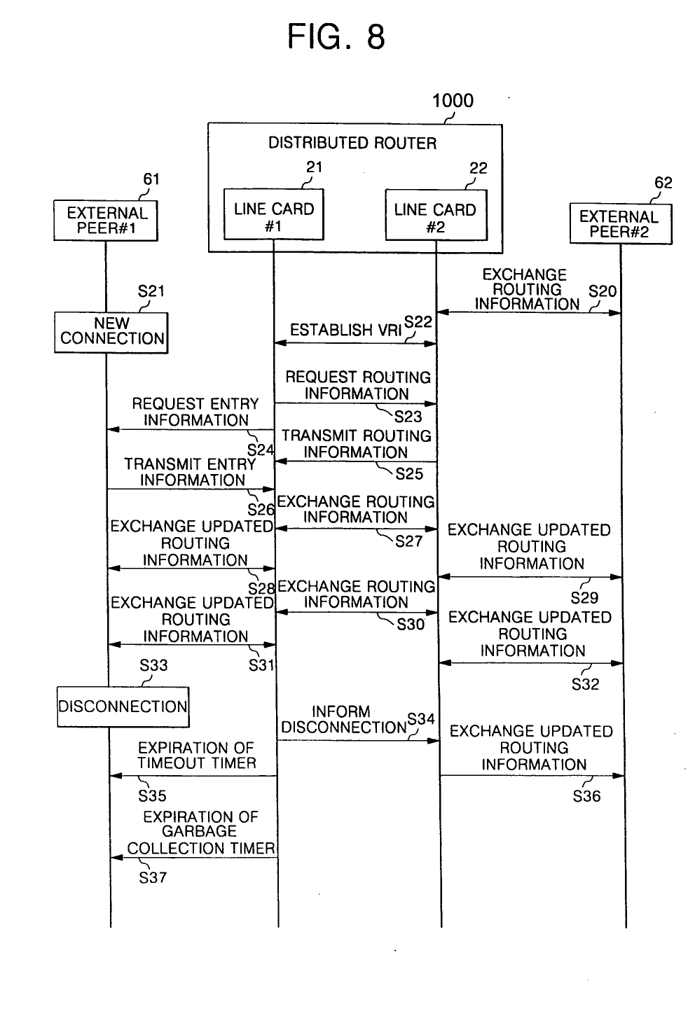

FIG. 8 is a view illustrating a procedure of exchanging messages between respective line cards of a distributed router according to an embodiment of the present invention.

A description follows with reference to FIG. 8 regarding the line card #1 21 being newly installed and connected to an external peer #1 61 when the line card #2 22 is installed in the distributed router 1000 and connected to an external peer #2 62.

First, when the line card #2 22 is connected to the external peer #2 62 and then the external peer #2 62 exchanges routing information with the routing processing unit 312 of the line card #2 22 (S20), the line card #1 21 is newly installed in the distributed router 1000 (S21).

The routing information exchanging units of the respective LCs 21 and 22 establish a VRI, that is—an internal communication path, between the respective LCs 21 and 22 (S22).

That is, the path establishing unit 331 of the routing information exchanging unit 313 initializes the VRI established with the respective LCs 21 to 26 to establish the VRI with the routing processors 31 to 36 of the other LCs 21 to 26.

The path establishing unit 334 stores information on the established VRI in the path storing unit 334.

The line card #1 21 transmits a routing information request message to the line card #2 22 in order to synchronize the routing information to be stored in the routing information storing unit 311 via the VRI established with the line card #2 22 (S23).

That is, the routing information synchronizing unit 332 of the line card #1 21 transmits the routing information request message to the routing information synchronizing unit 332 of the line card #2 22 via the established VRI.

The routing processing unit 312 of the line card #1 21 transmits an entry information request message to the external peer #1 61 connected via the port 51 (S24).

The line card #2 22 transmits the routing information stored in the routing information storing unit 311 to the line card #1 21 in response to the routing information request message transmitted from the line card #1 21 (S25).

The routing information synchronizing unit 332 of the line card #1 21 transmits the routing information request message to the line card #2 22, and the routing information synchronizing unit 332 of the line card #2 22 transmits a response message containing the routing information in response to the transmitted routing information request message or transmits the routing information stored in the routing information storing unit 311 while the line card #2 22 establishes the VRI with the newly installed line card #1 21.

The RIB managing unit 333 of the line card #1 21 generates or manages the routing information storing unit 311 according to the routing information transmitted from the line card #2 22.

That is, the RIB managing unit 333 of the line card #1 21 generates the routing information storing unit 311 when the routing information is transmitted from the line card #2 22 or updates the routing information stored in the routing information storing unit 311 when the routing information storing unit 311 has been already generated, thereby synchronizing the routing information among the LCs 21 to 26.

The external peer #1 61 transmits a response message containing the entry information to the line card #1 21 of the distributed router 1000 in response to the entry information request message transmitted from the line card #1 21 (S26).

The RIB managing unit 333 of the line card #1 21 changes the routing information of the routing information storing unit 311 according to the entry information transmitted from the external peer #1 61 and then transmits the changed routing information to the routing information synchronizing unit 332 of the line card #2 22.

The RIB managing unit 334 of the line card #2 22 changes the routing information stored in the routing information storing unit 311 according to the entry information and then transmits the changed routing information to the line card #1 21 when the changed entry information is transmitted from the external peer #2 62 (S27).

The external peer # 2 62 periodically transmits the entry information to the line card #2 22 according to the routing protocol processed in the routing processor 32 of the line card #1 22 or transmits the entry information to the line card #2 22 when updated entry information exists (S28).

The external peer # 1 61 transmits the entry information to the line card #1 21 periodically according to the routing protocol processed in the routing processor 31 of the line card #1 21 or transmits the entry information to the line card #1 21 when updated entry information exists (S29).

The routing information synchronizing units 332 of the respective LCs 21 and 22 update the routing information of the routing information storing unit 311 when the updated entry information is transmitted from the external peers 61 and 62 and then transmit the updated routing information to the other LCs 21 and 22 (S30).

The RIB managing units 333 of the respective LCs 21 and 22 change the routing information stored in the routing information storing unit 311 when the routing information is transmitted from the other LCs 21 to 26 so that the routing information stored in the respective LCs 21 to 26 can be maintained identically.

The routing processing unit 312 of the line card #1 21 transmits the routing information of the changed external peer #2 62 to the external peer #1 61 when the routing information for the external peer #2 62 is changed (S31), and the routing processing unit 312 of the line card #2 22 transmits the routing information of the changed external peer #1 61 to the external peer #2 62 when the routing information for the external peer #1 61 is changed (S32).

When a connection between the external peer #1 61 and the line card #1 21 is released (S33), the routing information exchanging unit 313 of the line card #1 21 informs the line card #2 22 that the connection with the external peer #1 61 has been released (S34).

The routing processing unit 312 of the line card #1 21 checks the timing out of a timeout timer to determine whether or not the connection with the external peer #1 61 has been released (S35).

The routing processing unit 312 of the line card #2 22 transmits the routing information changed by the disconnection from the external peer #1 61 to the external peer #2 62 (S36).

The routing processing unit 312 of the line card #1 21 checks the timing out of a garbage connection timer in order to delete the routing information of the external peer #1 61 from the routing information storing unit 311 when the timeout of the timeout timer has been checked with respect to the external peer #1 61 (S37).

When the timeout of a garbage collection time is checked with respect to the external peer #1 61, the line card #1 21 removes the routing information for the external peer #1 61 from the routing information storing unit 311 and then informs the line card #2 62 that the routing information of the external peer #1 61 has been removed.

The RIB managing unit 333 of the line card #2 22 removes the routing information of the external peer #1 61 from the routing information storing unit 311 so that the routing information of the respective LCs 21 to 26 can be maintained identically.

The forwarding processor 41 of the respective LCs 21 to 26 of FIG. 3 downloads the forwarding table 412 from the routing information storing unit 311 generated or managed by the routing processor 31 and forwards the packets to be transmitted from the external peer via the port 51.

The forwarding management unit 411 generates the forwarding table 412 based on the routing information of the routing information storing unit 311 generated in the routing processor 31 and changes the forwarding information stored in the forwarding table 412 when the routing information stored in the routing information storing unit 311 has been changed.

That is, the forwarding processor 41 generates or manages the forwarding table according to the routing information stored in the routing information storing unit 311 managed in the routing processor 31 according to the routing protocol. When the packet is transmitted from the external peer through the port 51, the forwarding processor 41 accesses the forwarding table 412 and outputs the packet via a corresponding output port.

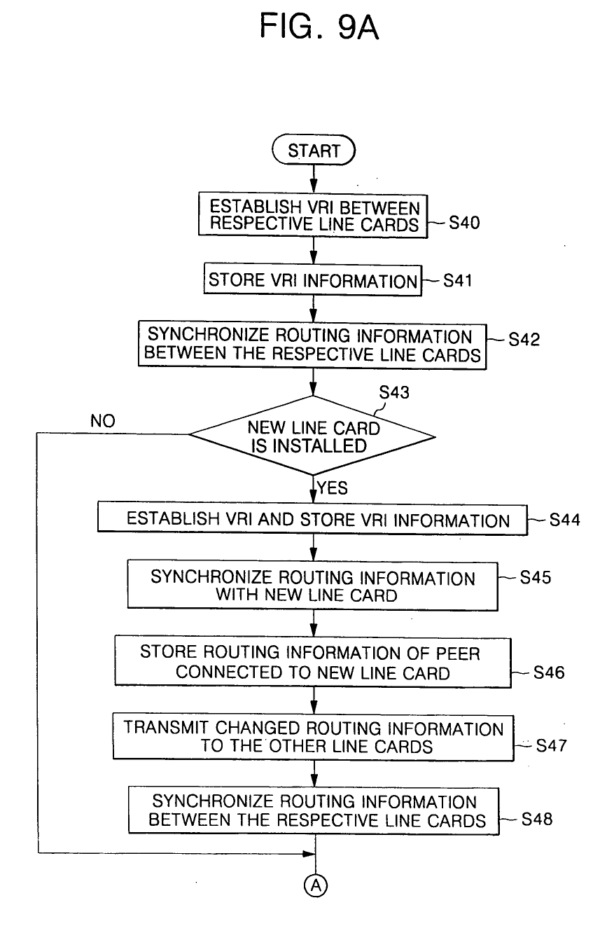

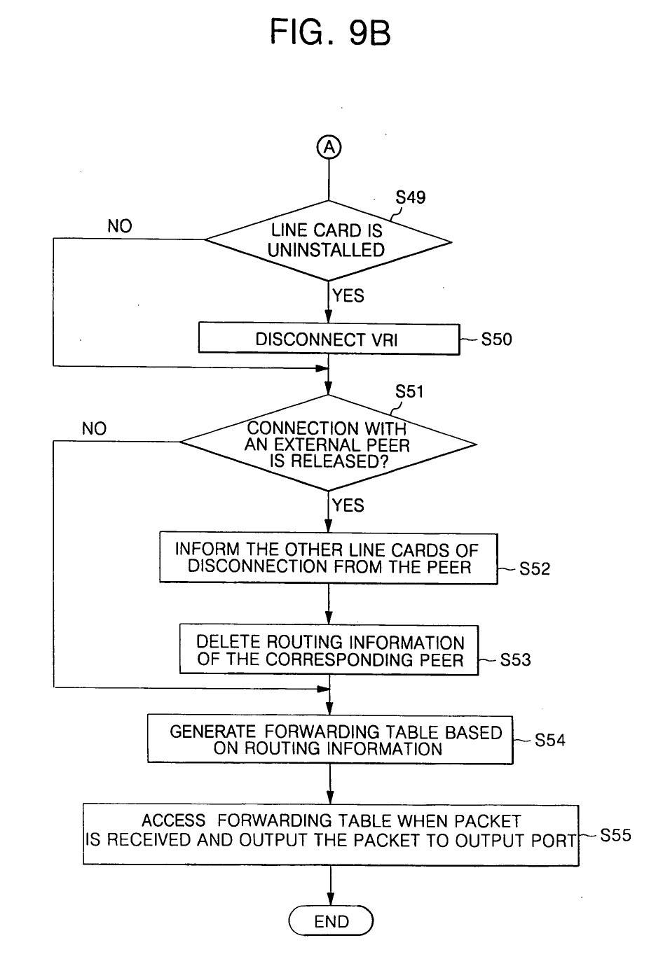

FIGS. 9A and 9B are flowcharts of a routing method of a distributed router according to an embodiment of the present invention.

Referring to FIGS. 9A and 9B, when the distributed router 1000 is initially driven, a VRI is established among the routing processors 31 to 36 of the respective LCs 21 to 26 (S40).

The path establishing units 334 of the respective LCs 21 to 26 establish a VRI with the routing processors 31 to 36 of the other LCs 21 to 26, and such a VRI can be established by a TCP channel establishing method, a multicast channel establishing method, a unicast channel establishing method, or the like.

The path establishing unit 334 stores information on the VRI established with the routing processors 31 to 36 of the other LCs 21 to 26 in the path storing unit (S41).

The routing processors 31 to 36 of the respective LCs 21 to 26 synchronize the routing information (S42).

The routing information synchronizing units 332 of the respective LCs 21 to 26 transmit the routing information request message via the VRI established with the other routing processors 31 to 36, and the RIB managing unit 333 stores the routing information transmitted in response to the routing information request message in the routing information storing unit 311.

The routing information synchronizing unit 332 transmits the routing information stored in the routing information storing unit 311 in response to the routing information request message transmitted from the other line processors 31 to 36.

When the routing information stored in the routing information storing units 311 of the respective LCs 21 to 26 are synchronized, a determination is made as to whether or not the new LCs 21 to 26 have been installed (S43). If the new LCs 21 to 26 have been installed, then the respective LCs 21 to 26 establish the VRI with the routing processors 31 to 36 of the newly installed LCs 21 to 26 and store the newly established VRI information in the path storing unit 334 (S44).

When the VRI is established with the other LCs 21 to 26, the routing information exchanging unit 313 of the new LCs 21 to 26 transmits the routing information request message via the VRI and stores the routing information transmitted in response to the routing information request message in the routing information storing unit 311. The routing information stored is identical to the respective LCs 21 to 26 (S45).

The routing processing unit 312 of the new LCs 21 to 26 transmits the entry information request message to the external peer connected via the port 51 and stores the routing information in the routing information storing unit 311 according to the entry information transmitted in response to the entry information request message (S46).

The routing information exchanging unit 313 of the new LCs 21 to 26 transmits the routing information changed according to the entry information of the external peer to the routing processors 31 to 36 of the respective LCs 21 to 26 via the VRI (S47).

That is, the routing information synchronizing unit 332 of the new LCs 21 to 26 transmits the routing information depending on the entry information transmitted from the external peer to the routing information synchronizing unit 332 of the other LCs 21 to 26 via the VRI.

The routing information exchanging unit 313 of the respective LCs 21 to 26 stores the routing information transmitted from the new LCs 21 to 26 in the routing information storing unit 311 (S48).

The routing processors 31 to 36 of the respective LCs 21 to 26 detect whether or not the other LCs 21 to 26 having the VRI established therewith have been uninstalled (S49), and disconnect the VRI established with the LCs 21 to 26 when the LCs 21 to 26 have been uninstalled, and store the fact that the VRI has been disconnected from the corresponding LCs 21 to 26 in the path storing unit 334 (S50).

That is, the path storing unit 331 of the routing processors 31 to 36 disconnects the VRI established with the removed LCs 21 to 26 and stores the fact the VRI has been disconnected from the corresponding LCs 21 to 26 in the path storing unit 334.

On the other hand, if the entry information is not transmitted from the external peer connected through the ports 51 to 56 for a predetermined time period, the respective LCs 21 to 26 check whether or not a connection with the external peer has been released (S51), and inform the routing processors 31 to 36 of the other LCs 21 to 26 that a connection with the corresponding external peer has been released when a connection with the corresponding external peer has been released (S52).

In order to determine whether a connection with the corresponding external peer has been safely released, the respective LCs 21 to 26 checks whether or not a message has been transmitted from the corresponding external peer for a predetermined time period and deletes the routing information for the corresponding external peer from the routing information storing unit 311 when a message has not transmitted for a predetermined time period (S53).

The routing information exchanging unit 313 of the LCs 21 to 26 informs the other LCs 21 to 26 that the routing information for the external peer has been deleted from the routing information storing unit 311, so that the routing information stored in the routing information storing unit 311 of the respective LCs 21 to 26 can be maintained identically.

The forwarding management unit 411 generates or manages the forwarding table 412 based on the routing information stored in the routing information storing unit 311 generated or managed in the routing processor 31 (S54).

That is, the forwarding management unit 411 generates the forwarding table 412 based on the routing information stored in the routing information storing unit 311 that the routing processor 31 generates while processing the entry information transmitted from the external peer according to the routing protocol.

When the routing processor 31 changes the routing information according to the entry information change of the external peer, the forwarding information changed according to the change is stored in the forwarding table 412.

The forwarding processor 41 accesses the forwarding information stored in the forwarding table 412 to output a packet through a corresponding output port when the packet is transmitted from the external peer (S55).

As described hereinbefore, the distributed router according to the present invention has an advantage of improving peer management efficiency by distributing a routing protocol processing function to a plurality of LCs and making the respective LCs manage the peer connected through a network.

Furthermore, it is possible to prevent a load caused by an increase in the number of peers connected to the distributed router by processing the routing protocol with respect to the peer connected independently in the respective LCs.

Still furthermore, it is possible to maximize the scalability of the entire system containing the distributed router by processing the best route processing for the corresponding peer while processing the routing protocol for the peer connected in the respective LCs.

1. A distributed router comprising:
a plurality of line cards;
a routing information storing unit adapted to store routing information of a peer connected to the distributed router via a network;
a routing processing unit adapted to determine a best route by processing entry information transmitted from the peer connected via the network according to a preset routing protocol, and to store the routing information of the peer in the routing information storing unit;
a routing information exchanging unit adapted to synchronize the routing information between the line cards by establishing an internal communication path with the line cards and exchanging the routing information with the line cards via the internal communication path; and
a forwarding processor adapted to generate forwarding information based on the routing information stored in the routing information storing unit and to process at least one packet transmitted from the network.

2. The distributed router as set forth in claim 1, wherein the routing protocol includes at least one of a Routing Information Protocol (RIP), an Open Shortest Path First (OSPF) protocol, an Inter-gateway Routing Protocol (IGRP), an Integrated Intermediate System to Intermediate System (IS-IS) protocol, an Exterior Gateway Protocol (EGP), and a Border Gateway Protocol (BGP).

3. The distributed router as set forth in claim 1, wherein the routing processing unit is adapted to determine the best route by processing the entry information changed according to the routing protocol and to store the changed routing information upon the changed routing information being transmitted from the peer.

4. The distributed router as set forth in claim 1, wherein the routing processing unit is adapted to delete the routing information of the peer from the routing information storing unit upon no entry information being transmitted from the peer for a predetermined time period.

5. The distributed router as set forth in claim 1, wherein the routing processing unit comprises:
a message processing unit adapted to transmit an entry information request message and to receive the entry information transmitted in response to the entry information request message upon the peer being connected; and
a route determining unit adapted to determine the best route by processing the entry information received through the message processing unit according the preset routing protocol and to store the routing information in the routing information storing unit.

6. The distributed router as set forth in claim 5, wherein the message processing unit is adapted to transmit the routing information in a predetermined period or to transmit the routing information upon the routing information being changed.

7. The distributed router as set forth in claim 5, wherein the route determining unit is adapted to determine the best route based on the changed entry information and to store changed routing information upon changed entry information being transmitted from the peer.

8. The distributed router as set forth in claim 1, wherein the routing information exchanging unit comprises:
a path establishing unit adapted to establish the internal communication path with the line cards;
a path storing unit adapted to storing information for the internal communication path established by the path establishing unit; and
a routing information synchronizing unit adapted to exchange the routing information with the line cards via the internal communication path established by the path establishing unit and to store routing information identical to the routing information stored in the line cards in the routing information storing unit.

9. The distributed router as set forth in claim 8, wherein the path storing unit is adapted to store at least one of information of a line card connected to the internal communication path established by the path establishing unit, information as to whether or not the internal communication path with a line card has been established, and information on a state of the internal communication path.

10. The distributed router as set forth in claim 8, wherein the path establishing unit is adapted to disconnect the established internal communication path and to store the disconnection of the internal communication path in the path storing unit upon at least one of the line cards being uninstalled from the distributed router.

11. The distributed router as set forth in claim 8, wherein the routing information synchronizing unit is adapted to transmit the changed routing information to the line cards through the internal communication path upon the routing information for the peers connected to the line cards being changed, and to update the stored routing information upon the changed routing information being received from the line cards.

12. The distributed router as set forth in claim 8, wherein the routing information synchronizing unit is adapted to delete the routing information of the peer connected to a line card from the routing information storing unit and to inform the line cards that the routing information has been deleted upon at least one of the line cards being uninstalled from the distributed router.

13. A distributed router, comprising:
a plurality of ports adapted to be connected to peers via a network, to receive messages containing packets and entry information from the peers, and to output the packets for transmission to destinations;
a switching fabric adapted to switch the packets received through the respective ports to output the packets to corresponding output ports; and
at least one line card adapted to extract the entry information of the peers from the messages received via the input ports, to process the entry information according to a preset routing protocol to determine a best route, and to output the packets received from the peers through the corresponding output ports according to the best route.

14. The distributed router as set forth in claim 13, wherein the line card comprises:
a routing information storing unit adapted to store routing information on a peer;
a routing processor adapted to determine the best route according to the entry information received via the respective input ports and to store the routing information of the best route in the routing information storing unit; and
a forwarding processor adapted to generate forwarding information based on the routing information stored in the routing information storing unit, to search the output ports of the packets received through the respective output ports from the forwarding information and to output the packets to the corresponding output ports.

15. A routing method comprising:
installing a plurality of line cards in a distributed router;
producing and storing routing information on peers connected via a network according to a routing protocol at respective line cards;
establishing an internal communication path between the line cards and exchanging the routing information stored in the line cards via the established internal communication path to synchronize the routing information;
transmitting the changed routing information via the internal communication path to the line cards and maintaining synchronization of the routing information upon the line cards having the routing information being changed;
generating forwarding information based on the stored routing information in the line cards; and
performing forwarding by a certain line card according to the generated forwarding information upon at least one packet being received.

16. The routing method as set forth in claim 15, further comprising:
deleting the routing information of the peers and informing the line cards of the deletion of the routing information upon a connection between the certain line card and the peer being released; and
determining a best route according to the entry information of the peer to store new routing information, and transmitting the new routing information to the line cards upon the certain line card being connected to a new peer.

17. The routing method as set forth in claim 15, further comprising:
establishing an internal communication path with a certain line card and storing information on the internal communication path upon the line card being newly installed in the distributed router;
determining the best route according to the entry information of the peer connected to the certain line card to store the routing information, and transmitting the routing information to the line cards through the internal communication path; and
disconnecting the internal communication path from the line card and storing information on the disconnection of the internal communication path upon the certain line card being uninstalled from the distributed router.

18. The routing method as set forth in claim 15, wherein the routing protocol includes at least one of a Routing Information Protocol (RIP), an Open Shortest Path First (OSPF) protocol, an Inter-gateway Routing Protocol (IGRP), an Integrated Intermediate System to Intermediate System (IS-IS) protocol, an Exterior Gateway Protocol (EGP), and a Border Gateway Protocol (BGP).

19. A routing method comprising:
installing a plurality of line cards in a distributed router;
producing and storing routing information for peers connected through a network according to a routing protocol of respective line cards;
establishing an internal communication path between the respective line cards, exchanging the routing information stored in the respective line cards through the established internal communication path, and synchronizing the routing information;
processing entry information of the peer according to the preset routing protocol to determine a best route, and transmitting the routing information to the line cards through the internal communication path upon the peer being connected to a certain line card through the network;
deleting the routing information of the peer and transmitting information on the deletion of the routing information to other line cards upon the certain line card being disconnected from the peer;
determining the best route based on the entry information of the peer according to the preset routing protocol to store new routing information and transmitting the new routing information to other line cards upon a new peer being connected to the certain line card; and
generating forwarding information based on the routing information stored in respective line cards and performing forwarding according to the generated forwarding information upon at least one packet being received.

20. The routing method as set forth in claim 19, wherein the routing protocol includes at least one of a Routing Information Protocol (RIP), an Open Shortest Path First (OSPF) protocol, an Inter-gateway Routing Protocol (IGRP), an Integrated Intermediate System to Intermediate System (IS-IS) protocol, an Exterior Gateway Protocol (EGP), and a Border Gateway Protocol (BGP).
